(19) United States
(12) Patent Application Publication
(10) Pub. No.: US 2021/0062049 A1
(43) Pub. Date: Mar. 4, 2021

(54) ADHESIVE TAPE

(71) Applicant: NITTO DENKO CORPORATION, Osaka (JP)

(72) Inventors: Yusuke YAMANARI, Ibaraki-shi (JP); Makoto SAITO, Ibaraki-shi (JP); Naoaki HIGUCHI, Ibaraki-shi (JP); Kenta JOZUKA, Ibaraki-shi (JP)

(73) Assignee: NITTO DENKO CORPORATION, Osaka (JP)

(21) Appl. No.: 16/959,313

(22) PCT Filed: Oct. 25, 2018
(86) PCT No.: PCT/JP2018/039661

§ 371 Date: Jun. 30, 2020

(30) Foreign Application Priority Data
Jan. 23, 2018 (JP) 2018-008572

(51) Int. Cl. C09J 7/38; C09J 7/25; B32B 7/023; B32B 7/06; B32B 7/12; B32B 27/40; B32B 27/10; B32B 27/08

(52) U.S. Cl. CPC C09J 7/385; C09J 7/25; B32B 7/023; B32B 7/06; B32B 7/12; B32B 27/40; B32B 2405/00; B32B 27/08; C09J 2475/00; C09J 2433/00; C09J 2301/124; C09J 2301/122; B32B 27/10

(57) ABSTRACT

Provided is a pressure-sensitive adhesive tape that is hard to see through even in the case where a tensile stress is applied thereto. The pressure-sensitive adhesive tape of the present invention includes: a base material layer; and a pressure-sensitive adhesive layer arranged on at least one side of the base material laver, wherein the pressure-sensitive adhesive tape has a total light transmittance T1 of 20% or less under a state of being elongated by a degree of elongation of 0%, and wherein the pressure-sensitive adhesive tape has a total light transmittance T2 of 30% or less under a state of being elongated by a degree of elongation of 100%.

### TECHNICAL FIELD

The present invention relates to a pressure-sensitive adhesive tape.

### BACKGROUND ART

The thickness of the display member of a portable electronic device typified by a smartphone has been reducing year by year. Such thin display member is easy to see through because of its thinness. Accordingly, the thin display member involves a problem in that its visibility is deteriorated by an influence of the unevenness or distortion of a support positioned on its back surface.

Herein, a pressure-sensitive adhesive tape has been used in the fixing of structures of various shapes in the portable electronic device (e.g., Patent Literatures 1 to 3). In view of the foregoing, the inventors of the present invention have paid attention to a pressure-sensitive adhesive tape to be bonded to a bending member as means for solving the above-mentioned visibility deterioration problem. That is, the inventors of the present invention have made an investigation on whether or not the deterioration of the visibility due to the influence of the unevenness or distortion of the support positioned on the back surface of the thin display member can be reduced by bonding the pressure-sensitive adhesive tape to the bending member. However, when the bending of the bending member is repeated, a tensile stress is applied to a related-art pressure-sensitive adhesive tape to reduce the thickness of its bent portion. Thus, the tape becomes easier to see through. Accordingly, it has been revealed that the related-art pressure-sensitive adhesive tape does not lead to the solution of the visibility deterioration problem.

### CITATION LIST

### Patent Literature

[PTL 1] JP 2015-165023 A
[PTL 2] JP 2016-029155 A
[PTL 3] JP 2016-113506 A

### SUMMARY OF INVENTION

### Technical Problem

An object of the present invention is to provide a pressure-sensitive adhesive tape that is hard to see through even in the case where a tensile stress is applied thereto.

### Solution to Problem

According to one embodiment of the present invention, there is provided a pressure-sensitive adhesive tape, including: a base material layer; and a pressure-sensitive adhesive layer arranged on at least one side of the base material layer, wherein the pressure-sensitive adhesive tape has a total light transmittance T1 of 20% or less under a state of being elongated by a degree of elongation of 0%, and wherein the pressure-sensitive adhesive tape has a total light transmittance T2 of 30% or less under a state of being elongated by a degree of elongation of 100%.

In one embodiment, the total light transmittance T1 is 10% or less.

In one embodiment, the total light transmittance T2 is 25% or less.

In one embodiment, the base material layer has a thickness of from 1 μm to 500 μm.

In one embodiment, the pressure-sensitive adhesive layer has a thickness of from 1 μm to 500 μm.

In one embodiment, the base material layer contains a base polymer and a colorant.

In one embodiment, the base material layer contains the colorant at a ratio of from 0.5 part by weight to 10 parts by weight with respect to 100 parts by weight of the base polymer.

In one embodiment, the base polymer is a thermoplastic elastomer.

In one embodiment, the thermoplastic elastomer is a polyurethane thermoplastic elastomer.

In one embodiment, the pressure-sensitive adhesive layer contains at least one kind selected from an acrylic pressure-sensitive adhesive, a rubber-based pressure-sensitive adhesive, a silicone-based pressure-sensitive adhesive, and a urethane-based pressure-sensitive adhesive.

In one embodiment, the pressure-sensitive adhesive layer contains a colorant.

### Advantageous Effects of Invention

According to the present invention, the pressure-sensitive adhesive tape that is hard to see through even in the case where a tensile stress is applied thereto can. be provided.

### BRIEF DESCRIPTION OF DRAWINGS

FIG. 1. is a schematic sectional view for illustrating one embodiment in the case where a pressure-sensitive adhesive tape of the present invention is a single-sided pressure-sensitive adhesive tape.

FIG. 2 is a schematic sectional view for illustrating one embodiment in the case where the pressure sensitive adhesive tape of the present invention. is a double-sided pressure-sensitive adhesive tape.

### DESCRIPTION OF EMBODIMENTS

### <<<<Pressure-Sensitive Adhesive Tape>>>>

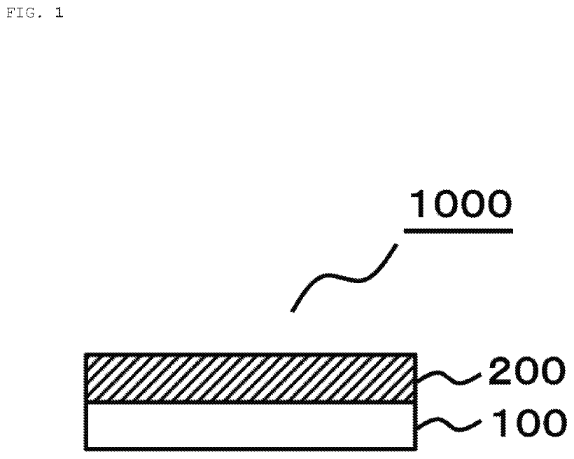

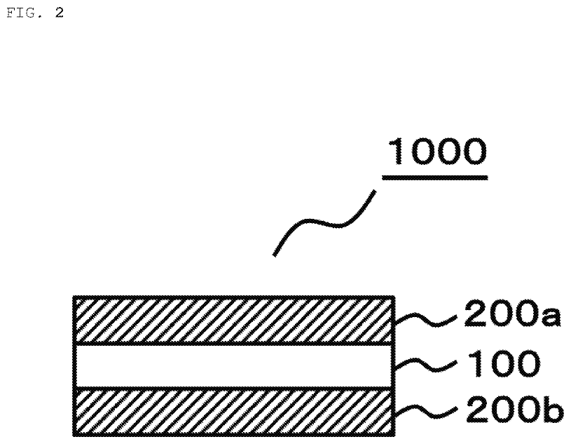

A pressure-sensitive adhesive tape of the present invention is a pressure-sensitive adhesive tape including: a base material layer; and a pressure-sensitive adhesive layer arranged on at least one side of the base material layer. That is, a pressure-sensitive adhesive tape 1000 of the present invention may be a pressure-sensitive adhesive tape (single -sided pressure-sensitive adhesive tape) including a pressure-sensitive adhesive layer 200 only on one side of a base material layer 100 as illustrated in FIG. 1, or may be a pressure-sensitive adhesive tape (double-sided pressure-sensitive adhesive tape) including pressure-sensitive adhesive layers 200a and 200b on both sides of the base material layer 100 as illustrated in FIG. 2.

The number of the base material layers may be one, or may be two or more. The number of the base material layers is preferably one because the effect of the present invention can be further expressed.

The number of the pressure-sensitive adhesive layers arranged on one side of the base material layer may be one, or may be two or more. The number of the pressure-sensitive adhesive layers is preferably one because the effect of the present invention can be further expressed.

The pressure-sensitive adhesive tape of the present invention may include any appropriate other layer except the base material layer and the pressure-sensitive adhesive layer to such an extent that the effect of the present invention is not impaired.

Any appropriate release liner may be arranged on the surface of the pressure-sensitive adhesive layer opposite to the base material layer for, for example, protecting the pressure-sensitive adhesive tape of the present. invention until its use.

Examples of the rel ease liner include: a release liner obtained by subjecting the surface of a base material (liner base material), such as paper or a plastic film, to a silicone treatment; and a release liner obtained by laminating a polyolefin-based resin on the surface of a base material (liner base material), such as paper or a plastic film. Examples of the plastic film serving as the liner base material include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release liner is preferably from 1 μm to 500 μm, more preferably from 3 μm to 450 μm, still more preferably from 5 μm to 400 μm, particularly preferably from 10 μm to 300 μm.

The total thickness of the pressure-sensitive adhesive tape of the present invention is preferably from 1 μm to 500 μm, more preferably from 5 μm to 400 μm, still more preferably from 10 μm to 350 μm, particularly preferably from 15 μm to 300 μm, most preferably from 20 μm to 250 μm. When the total thickness of the pressure-sensitive adhesive tape of the present invention falls within the range, the effect of the present invention can be further expressed.

The pressure-sensitive adhesive tape of the present invention has a total light transmittance T1 of preferably 20% or less, more preferably 15% or less, still more preferably 10% or less, particularly preferably 8% or less, most preferably 5% or less under a state of being elongated by a degree of elongation of 0%. The lower limit value of the total light transmittance T1 of the pressure-sensitive adhesive tape of the present invention in the state of being elongated by a degree of elongation of 0% is preferably 0% or more. When the total light transmittance T1 of the pressure-sensitive adhesive tape of the present invention in the state of being elongated by a degree of elongation of 0% falls within the range, the pressure-sensitive adhesive tape is hard to see through under a state in which substantially no tensile stress is applied thereto. Accordingly, for example, when such pressure-sensitive adhesive tape is bonded to a bending member in a portable electronic device having a thin display member, under a state in which the member is not bent, the deterioration of the visibility of the thin display member due to an influence of the unevenness or distortion of a support positioned on the back surface of the thin display member can be reduced.

The pressure-sensitive adhesive tape of the present invention has a total light transmittance T2 of preferably 30% or less, more preferably 25% or less, still more preferably 20% or less, particularly preferably 15% or less, most preferably 10% or less under a state of being elongated by a degree of elongation of 100%. The lower limit value of the total light transmittance T2 of the pressure-sensitive adhesive tape of the present invention in the state of being elongated by a degree of elongation of 100% is preferably 0% or more. When the total light transmittance T2 of the pressure-sensitive adhesive tape of the present invention in the state of being elongated by a degree of elongation of 100% falls within the range, the pressure-sensitive adhesive tape is hard to see through under a state in which a tensile stress is applied thereto. Accordingly, for example, when such pressure-sensitive adhesive tape is bonded to a bending member in a portable electronic device having a thin display member, under a state in which the member is bent, the deterioration of the visibility of the thin display member due to an influence of the unevenness or distortion of a support positioned on the back surface of the thin display member can be reduced.

It is preferred that the total light transmittance T1 of the pressure-sensitive adhesive tape of the present invention in the state of being elongated by a degree of elongation of 0% fall within the above-mentioned range, and the total light transmittance T2 thereof in the state of being elongated by a degree of elongation of 100% fall within the above-mentioned range. In the case where the pressure-sensitive adhesive tape of the present invention has such characteristics, for example, when such pressure-sensitive adhesive tape is bonded to a bending member in a portable electronic device having a thin display member, under any state of repeated bending of the member, the deterioration of the visibility of the thin display member due to an influence of the unevenness or distortion of a support positioned on the back surface of the thin display member can be reduced.

The pressure-sensitive adhesive tape of the present invention has a total light transmittance of preferably 25% or less, more preferably 20% or less, still more preferably 18% or less, particularly preferably 10% or less, most preferably 8% or less under a state of being elongated by a. degree of elongation of 50%. The lower limit value of the total light transmittance of the pressure-sensitive adhesive tape of the present invention in the state of being elongated by a degree of elongation of 50% s preferably 0% or more. When the total light transmittance of the pressure-sensitive adhesive tape of the present invention in the state of being elongated by a degree of elongation of 50% falls within the range, the pressure-sensitive adhesive tape is hard to see through under a state in which a tensile stress is applied thereto. Accordingly, for example, when such pressure-sensitive adhesive tape is bonded to a bending member in a portable electronic device having a thin display member, under a state in which the member is bent, the deterioration of the visibility of the thin display member due to an influence of the unevenness or distortion of a support positioned on the back surface of the thin display member can be reduced.

### <<Base Material Layer>>

The thickness of the base material layer is preferably from 1 μm to 500 μm, more preferably from 5 μm to 300 μm, still more preferably from 10 μm to 200 μm, particularly preferably from 15 μm to 150 μm, most preferably from 20 μm to 100 μm. When the thickness of the base material layer falls within the range, the pressure-sensitive adhesive tape of the present invention is harder to see through even in the case where a tensile stress is applied thereto.

The base material layer preferably contains a base polymer and a colorant.

The total content of the base polymer and the colorant in the base material layer is preferably from 50 wt % to 100 wt %, more preferably from 80 wt % to 100 wt %, still more preferably from 90 wt % to 100 wt %, particularly preferably from 95 wt % to 100 wt %, most preferably from 98 wt % to 100 wt %. When the total content of the base polymer and the colorant in the base material layer falls within the range, the pressure-sensitive adhesive tape of the present invention is harder to see through even in the case where a tensile stress is applied thereto.

The content of the colorant in the base material layer is preferably from 0.5 part by weight to 10 parts by weight, more preferably from 1.0 part by weight to 8.0 parts by weight, still more preferably from 1.5 parts by weight to 6.0 parts by weight, particularly preferably from 1.8 parts by weight to 4.0 parts by weight, most preferably from 2.0 parts by weight to 3.0 parts by weight with respect to 100 parts by weight of the base polymer. When the content of the colorant in the base material layer falls within the range, the pressure-sensitive adhesive tape of the present invention is harder to see through even in the case where a tensile stress is applied thereto.

Any appropriate base polymer may be adopted as the base polymer to such an extent that the effect of the present invention is not impaired. Such base polymer is preferably a thermoplastic elastomer. When the base polymer is the thermoplastic elastomer, the pressure-sensitive adhesive tape of the present invention is harder to see through even in the case where a tensile stress is applied thereto. When the thermoplastic elastomer is adopted as the base polymer, the number of kinds of the thermoplastic elastomers may be only one, or may be two or more.

Any appropriate thermoplastic elastomer may be adopted as the thermoplastic elastomer to such an extent that the effect of the present invention is not impaired. Examples of such thermoplastic elastomer include a polyurethane-based thermoplastic elastomer, a polyester-based thermoplastic elastomer, a polyamide-based thermoplastic elastomer, a polyolefin-based thermoplastic elastomer, and a polystyrene-based thermoplastic elastomer.

Any appropriate polyurethane-based thermoplastic elastomer (sometimes referred to as “TPU”) may be adopted as the polyurethane-based thermoplastic elastomer to such an extent that the effect of the present invention is not impaired. Such polyurethane-based thermoplastic elastomer is, for example, an ester-type polyurethane-based thermoplastic elastomer or an ether-type polyurethane-based thermoplastic elastomer depending on the kind of a polyol to be used at the time of the production of the elastomer by polymerzation.

Examples of the polyol that may be used in the ester-type polyurethane-based thermoplastic elastomer include ester-type polyols, such as polyethylene adipate (PEA), polybutylene adipate (PBA), polyhexamethylene adipate (PHA), poly-3-methylpentane adipate (PMPA), and polycaprolactone (PCL).

Examples of the polyol that may be used in the ether-type polyurethane-based thermoplastic elastomer include ether-type polyols, such as polyethylene glycol (PEG), polypropylene glycol (PPG), and polytetramethylene ether glycol (PTMG).

Any appropriate polyester-based thermoplastic elastomer may be adopted as the polyester-based thermoplastic elastomer to such an extent that the effect of the present invention is not impaired. Examples of such polyester-based thermoplastic elastomer include a polyester-ether-type polyester-based thermoplastic elastomer obtained by using polybutylene terephthalate (PBT) as a hard segment and polytetramellene ether glycol (PTMG) as a soft segment, and a polyester-ester-type polyester-based thermoplastic elastomer obtained by using polybutylene terephthalate (PBT) as a hard segment and polybutylene adipate (PBA) as a soft segment.

Any appropriate polyamide-based thermoplastic elastomer may be adopted as the polyamide-based thermoplastic elastomer to such an extent that the effect of the present invention is not impaired. Examples of such polyamide-based thermoplastic elastomer include a polyether ester-type polyamide-based thermoplastic elastomer obtained by using nylon 6, nylon 11, or nylon 12 as a hard segment and polyethylene glycol (PEG), polypropylene glycol (PPG), or polytetramethylene ether glycol (PTMG) as a soft segment, and a polyether amide-type polyamide-based thermoplastic elastomer obtained by using polypropylenediamine or polybutylenediamine as a soft segment.

Any appropriate polyolefin-based thermoplastic elastomer may be adopted as the polyolefin-based thermoplastic elastomer to such an extent that the effect of the present invention is not impaired. An example of such polyolefin-based thermoplastic elastomer is an elastomer obtained by using a polyolefin-based resin, such as polyethylene (PE) or polypropylene (PP), as a hard segment and a mixture of rubbers, such as an ethylene propylene rubber (PPM)) and an ethylene propylene diene rubber (EPDM), as a soft segment.

Any appropriate polystyrene-based thermoplastic elastomer may be adopted as the polystyrene-based thermoplastic elastomer to such an extent that the effect. of the present invention is not impaired. Examples of such polystyrene-based thermoplastic elastomer include a styrene ethylene butylene styrene block copolymer (SEBS), a styrene butadiene rubber (SBR), a styrene ethylene propylene styrene block copolymer (SEPS), styrene butadiene (SB), and a styrene block copolymer (SBC).

Any appropriate colorant may be adopted as the colorant to such an extent that the effect of the present invention is not impaired. The number of kinds of the colorants may be only one, or may be two or more. Examples of such colorant include a pigment and a dye.

Examples of the pigment include: inorganic pigments, such as zinc carbonate, zinc oxide, zinc sulfide, talc, kaolin, calcium carbonate, titanium oxide, silica, lithium fluoride, calcium fluoride, barium sulfate, alumina, zirconia, an iron oxide-based pigment, an iron hydroxide-based pigment, a chromium oxide-based pigment, a spinel-type calcined pigment, a chromic acid-based pigment, a chrome vermilion-based pigment, an iron blue-based pigment, an aluminum powder-based pigment, a bronze powder-based pigment, a silver powder-based pigment, and calcium phosphate; and organic pigments, such as a phthalocyanine-based pigment, an azo-based pigment, a condensed azo-based pigment, an azo lake-based pigment, an anthraquinone-based pigment, a perylene-perinone-based pigment, an indigo-based pigment, a thioindigo-based pigment, an isoindolinone-based pigment, an azomethine-based pigment, a dioxazine-based pigment, a quinacridone-based pigment, an aniline black-based pigment, a triphenylmethane-based pigment, and a carbon black-based pigment.

Examples of the dye include an azo-based dye, anthraquinone, quinophthalone, styryl, diphenylmethane, triphenylmethane, oxazine, triazine, xanthane, methane, azomethine, acridine, and diazine.

A black colorant is preferred as the colorant because the effect of the present invention can be further expressed with a small amount of the colorant. Specific examples of the black colorant include carbon black (e.g., furnace black, channel black, acetylene black, thermal black, lamp black, or turpentine soot), graphite, copper oxide, manganese dioxide, aniline black, perylene black, titanium black, cyanine black, activated carbon, ferrite (e.g., non-magnetic ferrite or magnetic ferrite), magnetite, chromium oxide, iron oxide, molybdenum disulfide, a chromium complex, and an anthraquinone-based colorant. Of those black colorants, carbon black is more preferred because the effect of the present invention can be further expressed.

A particulate colorant (pigment) is preferred as the colorant because the effect of the present invention can be further expressed with a small amount of the colorant. One preferred embodiment of such colorant is, for example, a particulate black colorant, such as carbon black. The average particle diameter of such colorant is preferably from 10 nm to 500 nm, more preferably from 10 nm to 120 nm. The term “average particle diameter” as used herein refers to a particle diameter at an integrated value of 50% in a particle size distribution measured on the basis of a particle size distribution-measuring apparatus based on a laser scattering-diffraction method (the particle diameter is a 50% volume average particle diameter, and is hereinafter sometimes abbreviated as “D50”) unless otherwise stated.

The base material layer may contain any appropriate other additive to such an extent that the effect of the present invention is not impaired. Examples of such other additive include a lubricant, an age resistor, an antistatic agent, a leveling agent, a cross-linking aid, a plasticizer, a softening agent, a filler, a UV absorber, an antioxidant, and a light stabilizer. The number of kinds of such other additives may be only one, or may be two or more.

The base material layer may be formed by any appropriate method to such an extent that the effect of the present invention is not impaired. Examples of such formation method include a coating method and an extrusion method.

The base material layer is preferably formed by the coating method. When the base material layer is formed by the coating method, a solution of the materials for the base material layer can be applied in a constant weight (thickness). In addition, when a solvent in the applied solution is volatilized, a coating film formed only of a solute can be formed. In addition, when the solid content concentration of the solution of the materials for the base material layer and the viscosity of the solution are adjusted, for example, the thickness unevenness of the film can be reduced. Thus, the effect of the present invention can be further expressed.

The solution of the material, for the base material layer is preferably applied while its temperature is kept constant in the range of from 10° C. to 40° C. because the effect of the present invention can be further expressed.

The concentration of the base polymer in the solution of the materials for the base material layer is preferably from 10 wt % to 50 wt %. When the concentration of the base polymer in the solution of the materials for the base material layer falls within the range, the pressure-sensitive adhesive tape of the present invention is harder to see through even in the case where a tensile stress is applied thereto.

The viscosity of the solution of the materials for the base material layer is preferably from 100 mPa·s to 50,000 mPa·s. When the viscosity of the solution of the materials for the base material layer falls within the range, the pressure-sensitive adhesive tape of the present invention is harder to see through even in the case where a tensile stress is applied thereto. The viscosity may be measured in conformity with JIS-K7117-1.

Any appropriate coater may be adopted as a coater to be used in the coating method to such an extent that the effect of the present invention is not impaired. Examples of such coater include a gravure coater, a reverse roll coater, a kiss coater, a roll knife coater, and a die coater. Of those coaters, a roll knife coater or a die coater is preferred because it becomes relatively easy to control the coating thickness of the film. In the case of the roll knife coater, the coating thickness can be uniformized by keeping a gap between a back-up roll and a knife roll constant; in the case of the die coater, the coating thickness can be uniformized by keeping the gap of a die orifice and the internal pressure of a die constant.

Any appropriate solvent may be adopted as the solvent in the solution of the materials for the base material layer to such an extent that the effect of the present invention is not impaired. Examples of such solvent include toluene, N,N-dimethylformamide (DMF) , methyl ethyl ketone (MEK) dimethylacetamide (DMAc), and ethyl acetate.

### <<Pressure-Sensitive Adhesive Layer>>

The thickness of the pressure-sensitive adhesive layer is preferably from 1 μm to 500 μm, more preferably from 3 μm to 300 μm, still more preferably from 5 μm to 200 μm, particularly preferably from 7 μm to 100 μm, most preferably from 10 μm to 70 μm. When the thickness of the pressure-sensitive adhesive layer falls within the range, the pressure-sensitive adhesive tape of the present invention is harder to see through even in the case where a tensile stress is applied thereto.

The pressure-sensitive adhesive layer preferably contains a base polymer. The number of kinds of the base polymers may be only one, or may be two or more. The content of the base polymer in the pressure-sensitive adhesive layer is preferably from 30 wt % to 95 wt % because the effect of the present invention can be further expressed, and the content is more preferably from 40 wt % to 90 wt %, still more preferably from 50 wt % to 80 wt %.

The pressure-sensitive adhesive layer may contain a colorant When the pressure-sensitive adhesive layer contains the colorant, the pressure-sensitive adhesive tape of the present invention is harder to see through even in the case where a tensile stress is applied thereto.

The content of the colorant in the pressure-sensitive adhesive layer is preferably from 0.5 part by weight to 10 parts by weight, more preferably from 1.0 part by weight to 8.0 parts by weight, still more preferably from 1.5 parts by weight to 6.0 parts by weight, particularly preferably from 1.8 parts by weight to 4.0 parts by weight, most preferably from 2.0 parts by weight to 3.0 parts by weight with respect to 100 parts by weight of the base polymer. When the content of the colorant in the pressure-sensitive adhesive layer falls within the range, the pressure-sensitive adhesive tape of the present invention is harder to see through even in the case where a tensile stress is applied thereto.

Any appropriate colorant may be adopted as the colorant to such an extent that the effect of the present invention is not impaired. The number of kinds of the colorants may be only one, or may be two or more. Examples of such colorant include a pigment and a dye.

Examples of the pigment include: inorganic pigments, such as zinc carbonate, zinc oxide, zinc sulfide, talc, kaolin, calcium carbonate, titanium oxide, silica, lithium fluoride, calcium fluoride, barium sulfate, alumina, zirconia, an iron oxide-based pigment, an iron hydroxide-based pigment, a chromium oxide-based pigment, a spinel-type calcined pigment, a chromic acid-based pigment, a chrome vermilion-based pigment, an iron blue-based pigment, an aluminum powder-based pigment, a bronze powder-based pigment, a silver powder-based pigment, and calcium phosphate; and organic pigments, such as a phthalocyanine-based pigment, an azo-based pigment, a condensed azo-based pigment, an azo lake-based pigment, an anthraquinone-based pigment, a perylene-perinone-based pigment, an indigo-based pigment, a thioindigo-based pigment, an isoindolinone-based pigment, an azomethine-based pigment, a dioxazine-based pigment, a guinacridone-based pigment, an aniline black-based pigment, a triphenylmethane-based pigment, and a carbon black-based pigment.

Examples of the dye include an azo-based dye, anthraquinone, quinophthalone, styryl, diphenylmethane, triphenylmethane, oxazine, triazine, xanthane, methane, azomethine, acridine, and diazine.

A black colorant is preferred as the colorant because the effect of the present invention can be further expressed with a small amount of the colorant. Specific examples of the black colorant include carbon black (e.g., furnace black, channel black, acetylene black, thermal black, lamp black, or turpentine soot), graphite, copper oxide, manganese dioxide, aniline black, perylene black, titanium black, cyanine black, activated carbon, ferrite (e.g., non-magnetic ferrite or magnetic ferrite), magnetite, chromium oxide, iron oxide, molybdenum disulfide, a chromium complex, and an anthraquinone-based colorant. Of those black colorants, carbon black is more preferred because the effect of the present invention can be further expressed.

A particulate colorant (pigment) is preferred as the colorant because the effect of the present invention can be further expressed with a small amount of the colorant. One preferred embodiment of such colorant is, for example, a particulate black colorant, such as carbon black. The average particle diameter of such colorant is preferably from 10 nm to 500 nm, more preferably from 10 nm to 120 nm. The term “average particle diameter” as used herein refers to a particle diameter at an integrated value of 50% in a particle size distribution measured on the basis of a particle size distribution-measuring apparatus based on a laser scattering-diffraction method (the particle diameter is a 50% volume average particle diameter, and is hereinafter sometimes abbreviated as “D50”) unless otherwise stated.

The base polymer is preferably, for example, at least one kind selected from an acrylic polymer, a rubber-based polymer, a silicone-based polymer, and a urethane-based polymer because the effect of the present invention can be further expressed. That is, the pressure-sensitive adhesive layer preferably contains at least one kind selected from an acrylic pressure-sensitive adhesive containing the acrylic polymer, a rubber-based pressure-sensitive adhesive containing the rubber-based polymer, a silicone-based pressure-sensitive adhesive containing the silicone-based polymer, and a urethane-based pressure-sensitive adhesive containing the urethane-based polymer. In the following description, the acrylic pressure-sensitive adhesive is described in detail as a typical example.

### <Acrylic Pressure-Sensitive Adhesive>

The acrylic pressure-sensitive adhesive contains the acrylic polymer as its base polymer. The acrylic pressure-sensitive adhesive may contain a tackifying resin. The acrylic pressure-sensitive adhesive may contain a cross-linking agent.

When the acrylic pressure-sensitive adhesive contains the acrylic polymer, the tackifying resin, and the cross-linking agent, the content of the sum total amount of the acrylic polymer, the tackifying resin, and the cross-linking agent with respect to the total amount of the acrylic pressure-sensitive adhesive is preferably 95 wt % or more because the effect of the present invention can be further expressed, and the content is more preferably 97 wt % or more, still more preferably 99 wt % or more.

### (Acrylic Polymer)

The acrylic polymer is preferably, for example, a polymerized product of monomer components that contain an alkyl (meth)acrylate as a main monomer and that may further contain a sub-monomer having copolymerizability with the main monomer. The term “main monomer” as used herein refers to a component accounting for more than 50 wt % of the entirety of the monomer components.

For example, a compound represented by the following formula (1) may be suitably used as the alkyl (meth)acrylate.

CH₂═C(R¹)COOR² (1)

Herein, in the formula (1), R¹ represents a hydrogen atom or a methyl group, and R² represents a chain-like alkyl group having 1 to 20 carbon atoms (hereinafter, such range of the number of carbon atoms is sometimes represented as “C1-20”). R² represents preferably a C1-14 chain-like alkyl group, more preferably a C2-10 chain-like alkyl group, still more preferably a C4-8 chain-like alkyl group from the viewpoint of, for example, the storage modulus of elasticity of the pressure-sensitive adhesive layer. The meaning of the term “chain-like” as used herein comprehends a linear group and a branched group.

Examples of the alkyl (meth)acrylate in which R² represents a C1-20 chain-like alkyl group include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, isostearyl (meth)acrylate, nonadecyl (meth)acrylate, and eicosyl (meth)acrylate. The number of kinds of those alkyl (meth)acrylates may be only one, or may be two or more.

The alkyl (meth)acrylate is preferably, for example, n-butyl acrylate (BA) or 2-ethylhexyl acrylate (2EHA) because the effect of the present invention can be further expressed.

The content of the alkyl (meth)acrylate in all the monomer components to be used in the synthesis of the acrylic polymer is preferably 70 wt % or more because the effect of the present invention can be further expressed, and the content is more preferably 85 wt % or more, still more preferably 90 wt % or more. The upper limit of the content of the alkyl (meth)acrylate is preferably 99.5 wt % or less, more preferably 99 wt % or less. However, the acrylic polymer may be obtained by polymerizing substantially only the alkyl (meth)acrylate.

When an alkyl (meth)acrylate in which R² represents a C4-8 chain-like alkyl group is used, the ratio of the alkyl (meth)acrylate in which R² represents a C4-8 chain-like alkyl group out of the alkyl (meth)acrylates in the monomer components is preferably 50 wt % or more because the effect of the present invention can be further expressed, and the ratio is more preferably 70 wt % or more, still more preferably 90 wt % or more, particularly preferably 95 wt % or more, most preferably from 99 wt % to 100 wt %.

An acrylic polymer in which n-butyl acrylate (BA) accounts for 50 wt % or more of all the monomer components is given as one embodiment of the acrylic polymer. In this case, the content of n-butyl acrylate (BA) in all the monomer components is preferably more than 50 wt % and 100 wt % or less because the effect of the present invention can be further expressed, and the content is more preferably from 55 wt % to 95 wt %, still more preferably from 60 wt % to 90 wt %, particularly preferably from 63 wt % to 85 wt %, most preferably from 65 wt % to 80 wt %. All the monomer components may further contain 2-ethylhexyl acrylate (2EHA) at a ratio smaller than that of n-butyl acrylate (BA).

An acrylic polymer in which 2-ethylhexyl acrylate (2EHA) accounts for less than 50 wt % of all the monomer components is given as one embodiment of the acrylic polymer. In this case, the content of 2-ethylhexyl acrylate (2EHA) in all the monomer components is preferably more than 0 wt % and 48 wt % or less because the effect of the present invention can be further expressed, and the content is more preferably from 5 wt % to 43 wt %, still more preferably from 10 wt % to 43 wt %, particularly preferably from 15 wt % to 40 wt %, most preferably from 20 wt % to 35 wt %. All the monomer components may further contain n-butyl acrylate (BA) at a ratio larger than that of 2-ethylhexyl acrylate (2EHA).

The acrylic polymer may be copolymerized with any other monomer to such an extent that the effect of the present invention is not impaired. The other monomer may be used for the purpose of, for example, adjusting the glass transition temperature (Tg) of the acrylic polymer or adjusting the pressure-sensitive adhesive performance thereof. As a monomer that may improve the cohesive strength and heat resistance of the pressure-sensitive adhesive, there are given, for example, a sulfonic acid group-containing monomer, a phosphoric acid group-containing monomer, a cyano group-containing monomer, a vinyl ester, and an aromatic vinyl compound. Of those, a vinyl ester is preferred. Specific examples of the vinyl ester include vinyl acetate (VAc), vinyl propionate, and vinyl laurate. Of those, vinyl acetate (VAc) is preferred.

The number of kinds of the “other monomers” may be only one, or may be two or more. The content of the other monomer in all the monomer components is preferably from 0.001 wt % to 40 wt %, more preferably from 0.01 wt % to 40 wt %, still more preferably from 0.1 wt % to 10 wt %, particularly preferably from 0.5 wt % to 5 wt %, most preferably from 1 wt % to 3 wt %.

Examples of the other monomer that may introduce a functional group capable of serving as a cross-linking base point into the acrylic polymer, or that may contribute to an improvement in adhesive strength include a hydroxy group (OH group)-containing monomer, a carboxy group-containing monomer, an acid anhydride group-containing monomer, an amide group-containing monomer, an amino group-containing monomer, an imide group-containing monomer, an epoxy group-containing monomer, (meth)acryloylmorpholine, and a vinyl ether.

An polymer copolymerized with the carboxy group-containing monomer as the other monomer is given as one embodiment of the acrylic polymer. Examples of the carboxy group-containing monomer include acrylic acid (AA), methacrylic acid (MAA), carboxyethyl (meth)acrylate, carboxypentyl (meth)acrylate, itaconic acid, maleic acid, fumaric acid, crotonic acid, and isocrotonic acid. Of those, the carboxy group-containing monomer is preferably, for example, acrylic acid (AA) or methacrylic acid (MAA), more preferably acrylic acid (AA) because the effect of the present invention can be further expressed.

When the carboxy group-containing monomer is adopted as the other monomer, the content of the other monomer in all the monomer components is preferably from 0.1 wt % to 10 wt % because the effect of the present invention can be further expressed, and the content is more preferably from 0.2 wt % to 8 wt %, still more preferably from 0.5 wt % to 5 wt %, particularly preferably from 0.7 wt % to 4 wt %, most preferably from 1 wt % to 3 wt %.

An acrylic polymer copolymerized with the hydroxy group-containing monomer as the other monomer is given as one embodiment of the acrylic polymer. Examples of the hydroxy group-containing monomer include: hydroxyalkyl (meth)acrylates, such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate; polypropylene glycol mono(meth)acrylate; and N-hydroxyethyl (meth)acrylamide. Of those, the hydroxy group-containing monomer preferably, for example, a hydroxyalkyl (meth)acrylate including a linear alkyl group having 2 to 4 carbon atoms because the effect of the present invention can be further expressed, and specific examples thereof include 2-hydroxyethyl acrylate (HEA) and 4-hydroxybutyl acrylate (4HBA). The hydroxy group-containing monomer is more preferably 4-hydroxybutyl acrylate (4HBA).

When the hydroxy group-containing monomer is adopted as the other monomer, the content of the other monomer in all the monomer components is preferably from 0.001 wt % to 10 wt % because the effect of the present invention can be further expressed, and the content is more preferably from 0.01 wt % to 5 wt %, still more preferably from 0.02 wt % to 2 wt %, particularly preferably from 0.03 wt % to 1 wt %, most preferably from 0.05 wt % to 0.5 wt %.

The Tg of the base polymer may be, for example, −80° C. or more because the effect of the present invention can be further expressed. The base polymer (suitably the acrylic polymer) is designed so that its Tg may be preferably −15° C. or less from the viewpoint of improving the deformability of the pressure-sensitive adhesive layer with respect to a shear direction. In some embodiments, the Tg of the base polymer is, for example, preferably −25° C. or less, more preferably −40° C. or less, still more preferably −50° C. or less. The base polymer is designed so that its Tg may be, for example, preferably −70° C. or more (more preferably −65° C. or more, still more preferably −60° C. or more) from the viewpoint of improving the cohesiveness and shape recoverability of the polymer.

The Tg of the base polymer refers to a value determined from Fox's equation on the basis of the Tg of a homopolymer of each monomer forming the base polymer and the weight fraction (copolymerization ratio on a weight basis) of the monomer. As described below, Fox's equation is a relational equation between the Tg of a copolymer and the glass transition temperature Tgi of a homopolymer obtained by the homopolymerization of each of monomers forming the copolymer.

1/Tg=Σ(Wi/Tgi)

In Fox's equation described above, Tg represents the glass transition temperature (unit: K) of the copolymer, Wi represents the weight fraction (copolymerization ratio on a weight basis) of a monomer “i” in the copolymer, and Tgi represents the glass transition temperature (unit: K) of the homopolymer of the monomer “i”. A value described in a known material is adopted as the Tg of a homopolymer.

Specifically, for example, the following values may each be used as the Tg of a homopolymer.

| | |
|---|---|
| 2-Ethylhexyl acrylate | −70° C. |
| n-Butyl acrylate | −55° C. |
| Acrylic acid | 106° C. |
| 2-Hydroxyethyl acrylate | −15° C. |
| 4-Hydroxybutyl acrylate | −40° C. |

A numerical value described in “Polymer Handbook” (3rd edition, John Wiley & Sons, Inc., 1989) may be used as the Tg of a homopolymer except those listed above. When a plurality of numerical values are described in the above-mentioned “Polymer Handbook”, a conventional value is adopted. With regard to a monomer that is not described in the above-mentioned “Polymer Handbook”, the catalog value of the manufacturer of the monomer is adopted. A value obtained by a measurement method described in JP 2007-51271 A is used as the Tg of a homopolymer of a monomer which is not described in the above-mentioned “Polymer Handbook” and for which the catalog value of the manufacturer of the monomer is not provided.

Various polymerization methods known as approaches to synthesizing acrylic polymers, such as a solution polymerization method, an emulsion polymerization method, a bulk polymerization method, and a suspension polymerization method, may each be appropriately adopted as a method of obtaining the acrylic polymer. Of those polymerization methods, the solution polymerization method may be preferably used. A collective loading system involving supplying the total amount of the monomer components in one stroke, a continuous supply (dropping) system, a divided supply (dropping) system, or the like may be appropriately adopted as a monomer supply method at the time of the performance of the solution polymerization. A polymerization temperature may be appropriately selected in accordance with, for example, the kinds of the monomers and a solvent to be used, and the kind of a polymerization initiator. The polymerization temperature is preferably 20° C. or more, more preferably 30° C. or more, still more preferably 40° C. or more, and is preferably 170° C. or less, more preferably 160° C. or less, still more preferably 140° C. or less. Such active energy ray irradiation polymerization as described below may be adopted as the method of obtaining the acrylic polymer photopolymerization performed (typically performed in the presence of a photopolymerization initiator) by irradiating the monomer components with light, such as UV; or radiation polymerization performed by irradiating the monomer components with a radiation, such as a β ray or a γ ray.

The solvent (polymerization solvent) to be used in the solution polymerization may be appropriately selected from any appropriate organic solvents. Examples thereof include: aromatic compounds (typically aromatic hydrocarbons), such as toluene; acetic acid esters, such as ethyl acetate; and aliphatic or alicyclic hydrocarbons, such as hexane and cyclohexane.

The initiator (polymerization initiator) to be used in the polymerization maybe appropriately selected from any appropriate polymerization initiators in accordance with the kind of the polymerization method. The number of kinds of the polymerization initiators maybe only one, or maybe two or more. Examples of such polymerization initiator include: azo-based polymerization initiators, such as 2,2′-azobisisobutyronitrile (AIBN); persulfuric acid salts, such as potassium persulfate; peroxide-based initiators, such as benzoyl peroxide and hydrogen peroxide; substituted ethane-based initiators, such as phenyl-substituted ethane; and aromatic carbonyl compounds. Other examples of the polymerization initiator include redox-type initiators each obtained by combining a peroxide and a reducing agent.

The usage amount of the polymerization initiator is preferably from 0.005 part by weight to part by weight, more preferably from 0.01 part by weight to 1 part by weight with respect to 100 parts by weight of all the monomer components.

The acrylic polymer has an Mw of preferably from 10×10⁴ to 500×10⁴, more preferably from 10×10⁴ to 150×10⁴, still more preferably from 20×10⁴ to 75×10⁴, particularly preferably from 35×10⁴ to 65×10⁴. Herein, the Mw refers to a value in terms of standard polystyrene obtained by gel permeation chromatography (GPC). For example, a product available under the model name “HLC-8320GPC” (column: TSKgel GMH-H (S), manufactured by Tosoh Corporation) may be used as a GPC apparatus.

### (Tackifying Resin)

The acrylic pressure-sensitive adhesive may contain a tackifying resin because the effect of the present invention can be further expressed. Examples of the tackifying resin include a rosin-based tackifying resin, a terpene-based tackifying resin, a hydrocarbon-based tackifying resin, an epoxy-based tackifying resin, a polyamide-based tackifying resin, an elastomer-based tackifying resin, a phenol-based tackifying resin, and a ketone-based tackifying resin. The number of kinds of the tackifying resins may be only one, or may be two or more.

The usage amount of the tackifying resin is preferably from 5 parts by weight to 70 parts by weight with respect to 100 parts by weight of the base polymer because the effect of the present invention can he further expressed, and the usage amount is more preferably from 10 parts by weight to 60 parts by weight, still more preferably from 15 parts by weight to 50 parts by weight, still further more preferably from 20 parts by weight to 45 parts by weight, particularly preferably from 25 parts by weight. to 40 parts by weight, most preferably from 25 parts by weight to 35 parts by weight.

The tackifying resin preferably contains a tackifying resin TL having a softening point of less than 105° C. because the effect of the present invention can be further expressed. The tackifying resin TL can effectively contribute to an improvement, in deformability of the pressure-sensitive adhesive layer in its plane direction (shear direction). The softening point of a tackifying resin to be used as the tackifying resin TL is preferably from 50° C. to 103° C., more preferably from 60° C. to 100° C., still more preferably from 65° C. to 95° C., particularly preferably from 70° C. to 90° C., most preferably from 75° C. to 85° C. from the viewpoint of obtaining a higher deformability-improving effect.

The softening point of the tackifying resin is defined as a value measured on the basis of a softening point test method (ring and ball method) specified in JIS K5902 and JIS K2207. Specifically, the sample is forthwith fused at as low a temperature as possible, and the fused sample is filled into a ring placed on a flat metal plate while attention is paid so that no bubbles may occur therein. After the sample has been cooled, a portion rising from a plane including the upper end of the ring is cut off with a knife that has been somewhat heated. Next, a support (ring stand) is loaded into a glass vessel (heating bath) having a diameter of 85 mm or more and a height of 127 mm or more, and glycerin is poured into the vessel until its depth becomes 90 mm or more. Next, a steel ball (having a diameter of 9.5 mm and a weight of 3.5 g) and the ring filled with the sample are immersed in glycerin so as not to be in contact with each other, and the temperature of glycerin is kept at 20° C.±5° C. for 15 minutes. Next, the steel ball is mounted on the center of the surface of the sample in the ring, and the resultant is placed at a fixed position on the support. Next, a distance from the upper end of the ring to the surface of glycerin is kept at 50 mm. A temperature gauge is placed in the vessel, and the position of the center of the mercury ball of the temperature gauge is set at the same height as that of the center of the ring, followed by the heating of the vessel. The flame of a Bunsen burner to be used in the heating is brought into contact with a midpoint between the center and edge of the bottom of the vessel so that the heating may be uniformly performed. The rate at which the temperature of the bath increases after having reached 40° C. since the start of the heating needs to be 5.0° C.±0.5° C. per minute. A temperature when the sample gradually softens to flow down from the ring, and is finally brought into contact with the bottom plate of the ring is read, and the read temperature is adopted as the softening point. The simultaneous measurement of the softening points of two or more samples is performed, and the average of the measured values is adopted.

The usage amount of the tackifying resin T1 is preferably from 5 parts by weight to parts by weight with respect to 100 parts by weight of the base polymer because the effect of the present invention can be further expressed, and the usage amount is more preferably from 10 parts by weight to 45 parts by weight, still more preferably from 15 parts by weight to 40 parts by weight, particularly preferably from 20 parts by weight to 35 parts by weight, most preferably from 25 parts by weight to 32 parts by weight.

One or two or more kinds appropriately selected from those each having a softening point of less than 105° C. out of the tackifying resins listed above may each be adopted as the tackifying resin TL. The tackifying resin TL preferably contains a rosin-based resin.

Examples of the rosin-based resin that may be preferably adopted as the tackifying resin TL include rosin esters, such as an unmodified rosin ester and a modified rosin ester. An example of the modified rosin ester is a hydrogenated rosin ester.

The tackifying resin TL preferably contains a hydrogenated rosin ester because the effect of the present invention can be further expressed. The softening point of the hydrogenated rosin ester is preferably less than 105° C. because the effect of the present invention can be further expressed, and the softening point is more preferably from 50° C. to 100° C., still more preferably from 60° C. to 90° C., particularly preferably from 70° C. to 85° C., most preferably from 75° C. to 85° C.

The tackifying resin IL may contain a non-hydrogenated rosin ester. The term “non-hydrogenated rosin ester” as used herein is a concept comprehensively referring to those except the hydrogenated rosin ester out of the above-mentioned rosin esters. Examples of the non-hydrogenated rosin ester include an unmodified rosin ester, a disproportionated rosin ester, and a polymerized rosin ester.

The softening point of the non-hydrogenated rosin ester is preferably less than 105° C. because the effect of the present invention can be further expressed, and the softening point is more preferably from 50° C. to 100° C., still more preferably from 60° C. to 90° C., particularly preferably from 70° C. to 85° C., most preferably from 75° C. to 85° C.

The tackifying resin TL may contain any other tackifying resin in addition to the rosin-based resin. One or two or more kinds appropriately selected from those each having a softening point of less than 105° C. out of the tackifying resins listed above may each be adopted as the other tackifying resin. The tackifying resin TL may contain, for example, the rosin-based resin and a terpene resin.

The content of the rosin-based resin in the entirety of the tackifying resin TL is preferably more than 50 wt % because the effect of the present invention can be further expressed, and the content is more preferably from 55 wt % to 100 wt %, still more preferably from 60 wt % to 99 wt %, particularly preferably from 65 wt % to 97 wt %, most preferably from 75 wt % to 97 wt %.

The tackifying resin may contain the tackifying resin TL and a tackifying resin TH having a softening point of 105° C. or more (preferably from 105° C. to 170° C.) in combination because the effect of the present invention can be further expressed.

One or two or more kinds appropriately selected from those each having a softening point of 105° C. or more out of the tackifying resins listed above may each be adopted as the tackifying resin TH. The tackifying resin TH may contain at least one kind selected from rosin-based tackifying resins (e.g., rosin esters) and terpene-based tackifying resins (e.g., a terpene phenol resin).

### (Cross-Linking Agent)

A cross-linking agent may be incorporated into the acrylic pressure-sensitive adhesive. The number of kinds of the cross-linking agents may be only one, or may be two or more. The use of the cross-linking agent can impart a moderate cohesive strength to the acrylic pressure-sensitive adhesive. The cross-linking agent may be useful in regulating an offset distance and a return distance in a holding power test. The acrylic pressure-sensitive adhesive containing the cross-linking agent may be obtained by, for example, forming the pressure-sensitive adhesive layer through the use of a pressure-sensitive adhesive composition containing the cross-linking agent. The cross-linking agent may be incorporated in, for example, a post-cross-linking reaction form, a pre-cross-linking reaction form, a form partially subjected to a cross-linking reaction, or an intermediate or composite form thereof into the acrylic pressure-sensitive adhesive. In typical cases, the cross-linking agent is exclusively incorporated in the post-cross-linking reaction form into the acrylic pressure-sensitive adhesive.

The usage amount of the cross-linking agent is preferably from 0.005 part by weight to 10 parts by weight with respect to 100 parts by weight of the base polymer because the effect of the present invention can be further expressed, and the usage amount is more preferably from 0.01 part by weight to 7 parts by weight, still further more preferably from 0.05 part by weight to 5 parts by weight, particularly preferably from 0.1 part by weight to 4 parts by weight, most preferably from 1 part by weight to 3 parts by weight.

Examples of the cross-linking agent include an isocyanate-based cross-linking agent, an epoxy-based cross-linking agent, a silicone-based cross-linking agent, an oxazoline-based cross-linking agent, an aziridine-based cross-linking agent, a silane-based cross-linking agent, an alkyl etherified melamine-based cross-linking agent, a metal chelate-based cross-linking agent, and a cross-linking agent such as a peroxide. Of those, an isocyanate-based cross-linking agent and an epoxy-based cross-linking agent are preferred, and an isocyanate-based cross-linking agent is more preferred because the effect of the present invention can be further expressed.

A compound having two or more isocyanate groups (including an isocyanate regenerative functional group obtained by temporarily protecting an isocyanate group by means of, for example, a blocking agent or oligomerization) in a molecule thereof may be used as the isocyanate-based cross-linking agent. Examples of the isocyanate-based cross-linking agent include: aromatic isocyanates, such as tolylene diisocyanate and xylene diisocyanate; alicyclic isocyanates, such as isophorone diisocyanate; and aliphatic isocyanates, such as hexamethylene diisocyanate.

More specific examples of the isocyanate-based cross-linking agent include: lower aliphatic polyisocyanates, such as butylene diisocyanate and hexamethylene diisocyanate; alicyclic isocyanates, such as cyclopentylene diisocyanate, cyclohexylene diisocyanate, and isophorone diisocyanate; aromatic diisocyanates, such as 2,4-tolylene diisocyanate, 4,4′-diphenylmethane diisocyanate, xylylene diisocyanate, and polymethylene polyphenyl isocyanate; isocyanate adducts, such as a trimethylolpropane/tolylene diisocyanate trimer adduct (e.g., product name: CORONATE L, manufactured by Tosoh Corporation), a trimethylolpropane/hexamethylene diisocyanate trimer adduct. (e.g., product name: CORONATE HL, manufactured by Tosoh Corporation), and an isocyanurate form of hexamethylene diisocyanate (e.g., product name: CORONATE HX, manufactured by Tosoh Corporation); a trimethylolpropane adduct of xylylene diisocyanate (e.g., product name: TAKENATE D110N, manufactured by Mitsui Chemicals, Inc.), a trimethylolpropane adduct of xylylene diisocyanate (e.g., prpduct name: TAKENATE D120N, manufactured. by Mitsui Chemicals, Inc.), a trimethylolpropane adduct of isophorone diisocyanate (e.g., product name: TAKENATE D140N, manufactured by Mitsui Chemicals, Inc.), and a trimethylolpropane adduct of hexamethylene diisocyanate (e.g., product name: TAKENATE D160N, manufactured by Mitsui Chemicals, Inc.); polyether polyisocyanate, polyester polyisocyanate, and adducts of those compounds and various polyols; and polyisocyanates each of which is polyfunctionalized with an isocyanurate bond, a biuret bond, or an alophanate bond. Of those, aromatic isocyanates and alicyclic isocyanates are preferred from the viewpoint that the deformability and the cohesive strength can be well balanced.

The usage amount of the isocyanate-based cross-linking agent is preferably from 0.005 part by weight to 10 parts by weight with respect to 100 parts by weight of the base polymer because the effect of the present invention can be further expressed, and the usage amount is more preferably from 0.01 part by weight to 7 parts by weight, still further more preferably from 0.05 part by weight to 5 parts by weight, particularly preferably from 0.1 part by weight to 4 parts by weight, most preferably from 1 part by weight to 3 parts by weight.

When the monomer components forming the acrylic polymer contain a hydroxy group-containing monomer, a weight ratio “isocyanate-based cross-linking agent/hydroxy group-containing monomer” is preferably more than 20 and less than 50 because the effect of the present invention can be further expressed, and the weight ratio is more preferably from 22 to 45, still more preferably from 25 to 40, particularly preferably from 27 to 40, most preferably from 30 to 35.

When the acrylic pressure-sensitive adhesive contains the tackifying resin TL having a softening point of 105° C. or less, a weight ratio “tackifying resin TL/isocyanate-based cross-linking agent” is preferably more than 2 and less than 15 because the effect of the present invention can be further expressed, and the weight ratio is more preferably from 5 to 13, still more preferably from 7 to 12, particularly preferably from 7 to 11.

A polyfunctional epoxy compound having two or more epoxy groups in a molecule thereof may be used as the epoxy-based cross-linking agent. Examples of the epoxy-based cross-linking agent include N,N,N′,N′-tetraglycidyl-m-xylenediamine, diglycidylaniline, 1,3-bis (N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic acid diglycidyl ester, triglycidyl-tris(2-hydroxyethyl) isocyanurate, resorcin diglycidyl ether, bisphenol-S-diglycidyi ether, and an epoxy-based resin having two or more epoxy groups in a molecule thereof. As a commercial product of the epoxy-based cross-linking agent, there is given, for example, a product available under the product name “TETRAD C” or “TETRAD X” from Mitsubishi Gas Chemical Company.

The usage amount of the epoxy-based cross-linking agent is preferably from 0.005 part by weight to 10 parts by weight with respect to 100 parts by weight of the base polymer because the effect of the present invention can be further expressed, and the usage amount is more preferably from 0.01 part by weight to 5 parts by weight, still more preferably from 0.015 part by weight to 1 part by weight, particularly preferably from 0.15 part by weight to 0.5 part by weight, most preferably from 0.015 part by weight to 0.3 part by weight.

### (Other Components)

The acrylic pressure-sensitive adhesive may contain any one of various additives that are general in the field of a pressure-sensitive adhesive, such as a leveling agent, a cross-linking aid, a plasticizer, a softening agent, a filler, an antistatic agent, an age resistor, a UV absorber, an antioxidant, and a light stabilizer, as required. Conventionally known additives may be used as such various additives by ordinary methods.

### EXAMPLES

Now, the present invention is more specifically described by way of Examples and Comparative Examples. However, the present invention is by no means limited thereto. In the following description, the terms “part(s)” and “%” are by weight unless otherwise stated.

### <Total Light Transmittance>

A release liner was peeled from the surface of one pressure-sensitive adhesive layer of a pressure-sensitive adhesive tape, and the pressure-sensitive adhesive layer on the surface from which the release liner had been peeled was bonded to a slide glass (manufactured by Matsunami Glass Ind., Ltd., product name: “S-1111”, total light transmittance=91.8%, haze=0.4%) without any wrinkle under a state in which the tape remained elongated by up to a predetermined degree of elongation. After that, in the case where a release liner was arranged on the other surface of the pressure-sensitive adhesive tape (e.g., in the case of a double-sided pressure-sensitive adhesive tape), the liner was peeled. Thus, a test piece (configuration: pressure-sensitive adhesive tape/slide glass) was produced. The total light transmittance of the produced test piece was measured with a haze meter (manufactured by Murakami Color Research Laboratory Co., Ltd., product name: “HM-150”).

For example, a case in which the degree of elongation is 0% means a case in which the tape is not elongated, a case in which the degree of elongation is 50% means a case in which the tape is elongated by a factor of 1.5, and a case in which the degree of elongation is 100% means a case in which the tape is elongated by a factor of 2.

### <Thickness>

Thickness measurement was performed with a thickness-measuring device “DIAL GAUGE 0.001 mm” manufactured by Ozaki Mfg. Co., Ltd.

### <Viscosity>

Measurement was performed with a viscometer “BH-TYPE VISCOMETER” manufactured by Toki Sangyo Co., Ltd. at a measurement temperature of 23° C. while its rotor No. 3 was rotated at 10 rpm.

### Example 1

### (Base Material Layer)

20.0 Parts of an ester-type polyurethane-based thermoplastic elastomer (TPU) serving as a base polymer, 0.5 part (2.5 parts with respect to 100 parts of the base polymer) of a black pigment (carbon black, manufactured by Dainichiseika Color & Chemicals Mfg. Co., Ltd., product name: “N-DYM 8715 BLACK”), 40 parts of N,N-dimethylformamide (DMF), and 40 parts of methyl ethyl ketone (MEK) were used to prepare a solution (1). The solution (1) was applied in a constant thickness onto the release surface of a commercial release liner (manufactured by Sumika-Kakoushi Co., Ltd., product name: “SLB-80W3D”) with a die coater under the coating film thickness setting of 250 μm while the temperature of the solution and the viscosity of the solution were kept constant at 23.0° C. and 5,000 mPa·s, respectively. The applied solution was dried at 100° C. for 2 minutes to form a base material layer (1) having a thickness of 50 μm on the release liner, followed by the peeling of the release liner. Thus, the base material layer (1) having a thickness of 50 μm was obtained.

### (Pressure-Sensitive Adhesive Layer)

30 Parts of 2-ethylhexyl acrylate (2EHA), 70 parts of n-butyl acrylate (BA), 3 parts of acrylic acid (AA), and 0.1 part of 4-hydroxybutyl acrylate (4HBA) serving as monomer components, 0.08 part of 2,2′-azobisisobutyronitrile (AIBN) serving as a polymerization initiator, and 150 parts of ethyl acetate serving as a polymerization solvent were loaded into a reaction vessel including a stirring machine, a temperature gauge, a nitrogen gas-introducing tube, and a condenser, and were subjected to solution polymerization at 65° C. for 8 hours to provide an ethyl acetate solution of an acrylic polymer (1). The acrylic polymer (1) had a weight-average molecular weight (Mw) of 40×10⁴.

30 Parts of a tackifying resin TA (manufactured by Harima Chemicals, Inc., hydrogenated rosin glycerin ester, product name: “HARITACK SE10”, softening point: from 75° C. to 85° C.) and 3.0 parts of an isocyanate-based cross-linking agent (manufactured by Tosoh Corporation, product name: “CORONATE L”) were added to 100 parts of the acrylic polymer (1) in the ethyl acetate solution. Thus, a pressure-sensitive adhesive composition (1) was prepared.

Two commercial release liners (manufactured by Sumika-Kakoushi Co., Ltd., product name: “SLB-80W3D”) were prepared. The pressure-sensitive adhesive composition (1) was applied to one surface (release surface) of each of the release liners so that its thickness after drying became 10 μm, followed by drying at 100° C. for 2 minutes. Thus, 10-micrometer thick pressure-sensitive adhesive layers (1) (a first pressure-sensitive adhesive layer (1) and a second pressure-sensitive adhesive layer (1)) each including an acrylic pressure-sensitive adhesive (1) corresponding to the pressure-sensitive adhesive composition (1) were formed on the release surfaces of the two release liners.

### (Pressure-Sensitive Adhesive Tape)

The first pressure-sensitive adhesive layer (1) and the second pressure-sensitive adhesive layer (1) formed on the two release liners were bonded to one surface (first surface) of the base material layer (1) and the other surface (second surface) thereof, respectively. The release liners were left as they were on the pressure-sensitive adhesive layers to be used for the protection of the surfaces of the pressure-sensitive adhesive layers. The resultant structure (release liner/first pressure-sensitive adhesive layer (1)/base material layer (1)/second pressure-sensitive adhesive layer (1)/release liner) was passed through a laminator at 80° C. (0.3 MPa, speed: 0.5 m/min) once, and was then aged in an oven at 50° C. for 1 day. Thus, a pressure-sensitive adhesive tape (1) that was a double-sided pressure-sensitive adhesive tape was obtained. The results are shown in Table 1.

### Example 2

### (Base Material Layer)

The base material layer (1) having a thickness of 50 μm was prepared in the same manner as in Example 1.

### (Pressure-Sensitive Adhesive Layer)

The 10-micrometer thick pressure-sensitive adhesive layer (1) was formed on the release surface of the release liner in the same manner as in Example 1 except that the only one release liner was prepared.

### (Pressure-Sensitive Adhesive Tape)

The pressure-sensitive adhesive layer (1) formed on the release liner was bonded to one surface of the base material layer (1) The release liner was left as at was on the pressure-sensitive adhesive layer to be used for the protection of the surface of the pressure-sensitive adhesive layer. The resultant structure (release liner/pressure-sensitive adhesive layer (1)/base material layer (1)) was passed through a laminator at 80° C. (0.3 MPa, speed: 0.5 m/min) once, and was then aged in an oven at 50° C. for 1 day. Thus, a pressure-sensitive adhesive tape (2) that was a single-sided pressure-sensitive adhesive tape was obtained. The results are shown in Table 1.

### Example 3

### (Base Material Layer)

The base material layer (1) having a thickness of 50 μm was prepared in the same manner as in Example 1.

### (Pressure-Sensitive Adhesive Layers)

The ethyl acetate solution of the acrylic polymer (1) was prepared in the same manner as in Example 1.

2 Parts of a black pigment (carbon black, manufactured by Dainichiseika Color & Chemicals Mfg. Co., Ltd., product name: “N-DYM 8715 BLACK”), 30 parts of a tackifying resin TA (manufactured by Harima Chemicals, Inc., hydrogenated rosin glycerin ester, product name: “HARITACK SE10”, softening point: from 75° C. to 85° C.), and 3.0 parts of an isocyanate-based cross-linking agent (manufactured by Tosoh Corporation, product name: “CORONATE L”) were added to 100 parts of the acrylic polymer (1) in the ethyl acetate solution. Thus, a pressure-sensitive adhesive composition (3) was prepared.

Two commercial release liners (manufactured by Sumika-Kakoushi Co., Ltd., product name: “SLB-80W3D”) were prepared. The pressure-sensitive adhesive composition (3) was applied to one surface (release surface) of each of the release liners so that its thickness after drying became 35 μm, followed by drying at 100° C. for 2 minutes. Thus, 35-micrometer thick pressure-sensitive adhesive layers (3) (a first pressure-sensitive adhesive layer (3) and a second pressure-sensitive adhesive layer (3)) each including an acrylic pressure-sensitive adhesive (3) corresponding to the pressure-sensitive adhesive composition (3) were formed on the release surfaces of the two release liners.

### (Pressure-Sensitive Adhesive Tape)

The first pressure-sensitive adhesive layer (3) and the second pressure-sensitive adhesive layer (3) formed on the two release liners were bonded to one surface (first surface) of the base material layer (1) and the other surface (second surface) thereof, respectively. The release liners were left as they were on the pressure-sensitive adhesive layers to be used for the protection of the surfaces of the pressure-sensitive adhesive layers. The resultant structure (release liner/first pressure-sensitive adhesive layer (3)/base material layer (1)/second pressure-sensitive adhesive layer (3)/release liner) was passed through a laminator at 80° C. (0.3 MPa, speed: 0.5 m/min) once, and was then aged in an oven at 50° C. for 1 day. Thus, a pressure-sensitive adhesive tape (3) that was a double-sided pressure-sensitive adhesive tape was obtained. The results are shown in Table 1.

### Example 4

### (Base Material Layer)

The base material layer (1) having a thickness of 50 μm was prepared in the same manner as in Example 1.

### (Pressure-Sensitive Adhesive Layer)

The 35-micrometer thick pressure-sensitive adhesive layer (3) was formed on the release surface of the release liner in the same manner as in Example 3 except that the only one release liner was prepared.

### (Pressure-Senstive Adhesive Tape)

The pressure-sensitive adhesive layer (3) formed on the release liner was bonded to one surface of the base material layer (3). The release liner was left as it was on the pressure-sensitive adhesive layer to be used for the protection of the surface of the pressure-sensitive adhesive layer. The resultant structure (release liner/pressure-sensitive adhesive layer (3)/base material layer (1)) was passed through a laminator at 80° C. (0.3 MPa, speed: 0.5 m/min) once, and was then aged in an oven at 50° C. for 1 day. Thus, a pressure-sensitive adhesive tape (4) that was a single-sided pressure-sensitive adhesive tape was obtained. The results are shown in Table 1.

### Comparative Example 1

### (Base Material Layer)

A base material layer (C1) having a thickness of 30 μm was prepared in the same manner as in Example 1 except that: the amount of the black pigment (carbon black, manufactured by Dainichiseika Color & Chemicals Mfg. Co., Ltd., product name: “N-DYM 8715 BLACK”) was changed to 0.1 part (0.5 part with respect to 100 parts of the base polymer); and the coating film thickness setting was changed to 150 μm.

### (Pressure-Sensitive Adhesive Layers)

The 10-micrometer thick pressure-sensitive adhesive layers (1) (the first pressure-sensitive adhesive layer (1) and the second pressure-sensitive adhesive layer (1)) were formed on the release surfaces of the two release liners in the same manner as in Example 1.

### (Pressure-Sensitive Adhesive Tape)

The first pressure-sensitive adhesive layer (1) and the second pressure-sensitive adhesive layer (1) formed on the two release liners were bonded to one surface (first, surface) of the base material layer (C1) and the other surface (second surface) thereof, respectively. The release liners were left as they were on the pressure-sensitive adhesive layers to be used for the protection of the surfaces of the pressure-sensitive adhesive layers. The resultant structure (release liner/first pressure-sensitive adhesive layer (1)/base material layer (C1)/second pressure-sensitive adhesive layer (1)/release liner) was passed through a laminator at 80° C. (0.3 MPa, speed: 0.5 m/min) once, and was then aged in an oven at 50° C. for 1 day. Thus, a pressure-sensitive adhesive tape (C1) that was a double-sided pressure-sensitive adhesive tape was obtained. The results are shown in Table 1.

### Comparative Example 2

### (Base Material Layer)

The base material layer (C1) having a thickness of 30 μm was prepared in the same manner as in Comparative Example 1.

### (Pressure-Sensitive Adhesive Layer)

The 10-micrometer thick pressure-sensitive adhesive layer (1) was formed on the release surface of the release liner in the same manner as in Comparative Example 1 except that the only one release liner was prepared.

### (Pressure-Sensitive Adhesive Tape)

The pressure-sensitive adhesive layer (1) formed on the release liner was bonded to one surface of the base material layer (C1). The release liner was left as it was on the pressure-sensitive adhesive layer to be used for the protection of the surface of the pressure-sensitive adhesive layer. The resultant structure (release liner/pressure-sensitive adhesive layer (1)/base material layer (C1)) was passed through a laminator at 80° C. (0.3 MPa, speed: 0.5 m/min) once, and was then aged in an oven at 50° C. for 1 day. Thus, a pressure-sensitive adhesive tape (C2) that was a single-sided pressure-sensitive adhesive tape was obtained. The results are shown in Table 1.

### Comparative Example 3

A base material layer (C3) having a thickness of 50 μm was prepared in the same manner as in Example 1 except that the amount of the black pigment (carbon black, manufactured by Dainichiseika Color & Chemicals Mfg. Co., Ltd., product name: “N-DYM 8715 BLACK”) was changed to 0.1 part (0.5 part with respect to 100 parts of the base polymer).

### (Pressure-Sensitive Adhesive Layers)

The 10-micrometer thick pressure-sensitive adhesive layers (1) (the first pressure-sensitive adhesive layer (1) and the second pressure-sensitive adhesive layer (1)) were formed on the release surfaces of the two release liners in the same manner as in Example 1.

### (Pressure-Sensitive Adhesive Tape)

The first pressure-sensitive adhesive layer (1) and the second pressure-sensitive adhesive layer (1) formed on the two release liners were bonded to one surface (first surface) of the base material layer (C3) and the other surface (second surface) thereof, respectively. The release liners were left as they were on the pressure-sensitive adhesive layers to be used for the protection of the surfaces of the pressure-sensitive adhesive layers. The resultant structure (release liner/first pressure-sensitive adhesive layer (1)/base material layer (C3)/second pressure-sensitive adhesive layer (1)/release liner) was passed through a laminator at 80° C. (0.3 MPa, speed: 0.5 m/min) once, and was then aged in an oven at 50° C. for 1 day. Thus, a pressure-sensitive adhesive tape (C3) that was a double-sided pressure-sensitive adhesive tape was obtained. The results are shown in Table 1.

### Comparative Example 4

### (Base Material Layer)

The base material layer (C3) having a thickness of 50 μm was prepared in the same manner as in Comparative Example 3.

### (Pressure-Sensitive Adhesive Layer)

The 10-micrometer thick pressure-sensitive adhesive layer (1) was formed on the release surface of the release liner in the same manner as in Comparative Example 3 except that the only one release liner was prepared.

### (Pressure-Sensitive Adhesive Tape)

The pressure sensitive adhesive layer (1) formed on the release liner was bonded to one surface of the base material layer (C3). The release liner was left as it was on the pressure-sensitive adhesive layer to be used for the protection of the surface of the pressure-sensitive adhesive layer. The resultant structure (release liner/pressure-sensitive adhesive layer (1)/base material layer (C3)) was passed through a laminator at 80° C. (0.3 MPa, speed: 0.5 m/min) once, and was then aged in an oven at 50° C. for 1 day. Thus, a pressure-sensitive adhesive tape (C4) that was a single-sided pressure-sensitive adhesive tape was obtained. The results are shown in Table 1.

### Comparative Example 5

### (Base Material Layer)

A base material layer (C5) having a thickness of 60 μm was prepared in the same manner as in Example 1 except that: the amount of the black pigment (carbon black, manufactured by Dainichiseika Color & Chemicals Mfg. Co., Ltd., product name: “N-DYM 8715 BLACK”) was changed to 0.1 part (0.5 part with respect to 100 parts of the base polymer); and the coating film thickness setting was changed to 300 μm.

### (Pressure-Sensitive Adhesive Layers)

The 10-micrometer thick pressure-sensitive adhesive layers (1) (the first pressure-sensitive adhesive layer (1) and the second pressure-sensitive adhesive layer (1)) were formed on the release surfaces of the two release liners in the same manner as in Example 1.

### (Pressure-Sensitive Adhesive Tape)

The first pressure-sensitive adhesive layer (1) and the second pressure-sensitive adhesive layer (1) formed on the two release liners were bonded to one surface (first surface) of the base material layer (C5) and the other surface (second surface) thereof, respectively. The release liners were left as they were on the pressure-sensitive adhesive layers to be used for the protection of the surfaces of the pressure-sensitive adhesive layers. The resultant structure (release liner/first pressure-sensitive adhesive layer (1)/base material layer (C5)/second pressure-sensitive adhesive layer (1)/release liner) was passed through a laminator at 80° C. (0.3 MPa, speed: 0.5 m/min) once, and was then aged in an oven at 50° C. for 1 day. Thus, a pressure-sensitive adhesive tape (C5) that was a double-sided pressure-sensitive adhesive tape was obtained. The results are shown in Table 1.

### Comparative Example 6

### (Base Material Layer)

The base material layer (C5) having a thickness of 60 μm was prepared in the same manner as in Comparative Example 5.

### (Pressure-Sensitive Adhesive Layer)

The 10-micrometer thick pressure-sensitive adhesive layer (1) was formed on the release surface of the release liner in the same manner as in Comparative Example 5 except that the only one release liner was prepared.

### (Pressure-Sensitive Adhesive Tape)

The pressure-sensitive adhesive layer (1) formed on the release liner was bonded to one surface of the base material layer (C5). The release liner was left as it was on the pressure-sensitive adhesive layer to be used for the protection of the surface of the pressure-sensitive adhesive layer. The resultant structure (release liner/pressure-sensitive adhesive layer (1)/base material layer (C5)) was passed through a laminator at 80° C. (0.3 MPa, speed: 0.5 m/min) once, and was then aged in an oven at 50° C. for 1 day. Thus, a pressure-sensitive adhesive tape (C6) that was a single-sided pressure-sensitive adhesive tape was obtained. The results are shown in Table 1.

### Comparative Example 7

### (Base Material Layer)

A 54.5-micrometer thick base material layer having a black printed layer on the entirety of one surface of a polyethylene terephthalate film (thickness of the PET layer=50 μm, thickness of the black printed layer=4.5 μm) was used as a base material layer (C7).

### (Pressure-Sensitive Adhesive Layers)

The 10-micrometer thick pressure-sensitive adhesive layers (1) (the first pressure-sensitive adhesive layer (1) and the second pressure-sensitive adhesive layer (1)) were formed on the release surfaces of the two release liners in the same manner as in Example 1.

### (Pressure-Sensitive Adhesive Tape)

The first pressure-sensitive adhesive layer (1) and the second pressure-sensitive adhesive layer (1) formed on the two release liners were bonded to one surface (first surface) of the base material layer (C7) and the other surface (second surface) thereof, respectively. The release liners were left as they were on the pressure-sensitive adhesive layers to be used for the protection of the surfaces of the pressure-sensitive adhesive layers. The resultant structure (release liner/first pressure-sensitive adhesive layer (1)/base material layer (C7)/second pressure-sensitive adhesive layer (1)/release liner) was passed through a laminator at 80° C. (0.3 MPa, speed: 0.5 m/min) once, and was then aged in an oven at 50° C. for 1 day. Thus, a pressure-sensitive adhesive tape (C7) that was a double-sided pressure-sensitive adhesive tape was obtained. The results are shown in Table 1.

### Comparative Example 8

### (Base Material Layer)

The base material layer (C7) having a thickness of 54.5 μm was prepared in the same manner as in Comparative Example 7.

### (Pressure-Sensitive Adhesive Layer)

The 10-micrometer thick pressure-sensitive adhesive layer (1) was formed on the release surface of the release liner in the same manner as in. Comparative Example 7 except that the only one release liner was prepared.

### (Pressure-Sensitive Adhesive Tape)

The pressure-sensitive adhesive layer (1) formed on the release liner was bonded to one surface of the base material layer (C7). The release liner was left as it was on the pressure-sensitive adhesive layer to be used for the protection of the surface of the pressure-sensitive adhesive layer. The resultant structure (release liner/pressure-sensitive adhesive layer (1)/base material layer (C7)) was passed through a laminator at 80° C. (0.3 MPa, speed: 0.5 m/min) once, and was then aged in an oven at 50° C. for 1 day. Thus, a pressure-sensitive adhesive tape (C8) that was a single-sided pressure-sensitive adhesive tape was obtained. The results are shown in Table 1.

TABLE 1

| | | | | | Compar- | Compar- | Compar- | Compar- | Compar- | Compar- | Compar- | Compar- |
|---|---|---|---|---|---|---|---|---|---|---|---|---|
| | Ex- | Ex- | Ex- | Ex- | ative | ative | ative | ative | ative | ative | ative | ative |
| | am- | am- | am- | am- | Example | Example | Example | Example | Example | Example | Example | Example |
| | ple 1 | ple 2 | ple 3 | ple 4 | 1 | 2 | 3 | 4 | 5 | 6 | 7 | 8 |
| Material for base | TPU | TPU | TPU | TPU | TPU | TPU | TPU | TPU | TPU | TPU | PET | PET |
| polymer of base | | | | | | | | | | | (black | (black |
| material layer | | | | | | | | | | | printed | printed |
| | | | | | | | | | | | layer) | layer) |
| Color of base | Black | Black | Black | Black | Black | Black | Black | Black | Black | Black | Black | Black |
| material | | | | | | | | | | | | |
| layer | | | | | | | | | | | | |
| Content of colorant | 2.5 | 2.5 | 2.5 | 2.5 | 0.5 | 0.5 | 0.5 | 0.5 | 0.5 | 0.5 | — | — |
| with respect to base | | | | | | | | | | | | |
| polymer in base | | | | | | | | | | | | |
| material layer | | | | | | | | | | | | |
| (%) | | | | | | | | | | | | |
| Color of pressure- | Trans- | Trans- | Black | Black | Trans- | Trans- | Trans- | Trans- | Trans- | Trans- | Trans- | Trans- |
| sensitive | parent | parent | | | parent | parent | parent | parent | parent | parent | parent | parent |
| adhesive layer | | | | | | | | | | | | |
| Content of colorant | 0 | 0 | 2 | 2 | 0 | 0 | 0 | 0 | 0 | 0 | 0 | 0 |
| with respect to | | | | | | | | | | | | |
| acrylic polymer in | | | | | | | | | | | | |
| pressure-sensitive | | | | | | | | | | | | |
| adhesive layer (%) | | | | | | | | | | | | |
| Arrangement of | Both | One | Both | One | Both | One | Both | One | Both | One | Both | One |
| pressure-sensitive | sides | side | sides | side | sides | side | sides | side | sides | side | sides | side |
| adhesive layer with | | | | | | | | | | | | |
| respect to base | | | | | | | | | | | | |
| material layer | | | | | | | | | | | | |
| Thickness of base | 50 | 50 | 50 | 50 | 30 | 30 | 50 | 50 | 60 | 60 | 54.5 | 54.5 |
| material layer (μm) | | | | | | | | | | | | |
| Thickness of | 10 | 10 | 35 | 35 | 10 | 10 | 10 | 10 | 10 | 10 | 10 | 10 |
| pressure-sensitive | | | | | | | | | | | | |
| adhesive layer (μm) | | | | | | | | | | | | |
| Thickness of | 70 | 60 | 120 | 85 | 50 | 40 | 70 | 60 | 80 | 70 | 74.5 | 64.5 |
| pressure-sensitive | | | | | | | | | | | | |
| adhesive tape (μm) | | | | | | | | | | | | |
| Total light transmit- | 8.6 | 8.6 | 0.0 | 0.0 | 42.9 | 44.6 | 34.4 | 35.5 | 23.1 | 23.3 | 1.8 | 1.9 |
| tance T1 in state of | | | | | | | | | | | | |
| being elongated by | | | | | | | | | | | | |
| degree of elongation | | | | | | | | | | | | |
| of 0% (%) | | | | | | | | | | | | |
| Total light transmit- | 14.9 | 15.9 | 4.6 | 4.9 | 49.1 | 49.3 | 38.0 | 38.7 | 26.8 | 27.9 | 2.2 | 2.4 |
| tance in state of | | | | | | | | | | | | |
| being elongated by | | | | | | | | | | | | |
| degree of elongation | | | | | | | | | | | | |
| of 50% (%) | | | | | | | | | | | | |
| Total light transmit- | 19.8 | 20.2 | 6.7 | 7.2 | 56.0 | 56.1 | 42.6 | 44.3 | 33.7 | 34.2 | No | No |
| tance T2 in state of | | | | | | | | | | | elonga- | elonga- |
| being elongated by | | | | | | | | | | | tion | tion |
| degree of elongation | | | | | | | | | | | | |
| of 100% (%) | | | | | | | | | | | | |

### INDUSTRIAL APPLICABILITY

The pressure-sensitive adhesive tape of the present invention may be preferably utilized as, for example, a pressure-sensitive adhesive tape to be bonded to a member having a movable bending portion.

### REFERENCE SIGNS LIST

1000 pressure-sensitive adhesive tape
100 base material layer
200 pressure-sensitive adhesive layer
200a pressure-sensitive adhesive layer
200b pressure-sensitive adhesive layer

1. A pressure-sensitive adhesive tape, comprising:
a base material layer; and
a pressure-sensitive adhesive layer arranged on at least one side of the base material layer,
wherein the pressure-sensitive adhesive tape has a total light transmittance T1 of 20% or less under a state of being elongated by a degree of elongation of 0%, and
wherein the pressure-sensitive adhesive tape has a total light transmittance T2 of 30% or less under a state of being elongated by a degree of elongation of 100%.

2. The pressure-sensitive adhesive tape according to claim 1, wherein the total light transmittance T1 is 10% or less.

3. The pressure-sensitive adhesive tape according to claim 1, wherein the total light transmittance T2 is 25% or less.

4. The pressure-sensitive adhesive tape according to claim 1, wherein the base material layer has a thickness of from 1 μm to 500 μm.

5. The pressure-sensitive adhesive tape according to claim 1, wherein the pressure-sensitive adhesive layer has a thickness of from 1 μm to 500 μm.

6. The pressure-sensitive adhesive tape according to claim 1, wherein the base material layer contains a base polymer and a colorant.

7. The pressure-sensitive adhesive tape according to claim 6, wherein the base material layer contains the colorant at a ratio of from 0.5 part by weight to 10 parts by weight with respect to 100 parts by weight of the base polymer.

8. The pressure-sensitive adhesive tape according to claim 6, wherein the base polymer is a thermoplastic elastomer.

9. The pressure-sensitive adhesive tape according to claim 8, wherein the thermoplastic elastomer is a polyurethane thermoplastic elastomer.

10. The pressure-sensitive adhesive tape according to claim 1, wherein the pressure-sensitive adhesive layer contains at least one kind selected from an acrylic pressure-sensitive adhesive, a rubber-based pressure-sensitive adhesive, a silicone-based pressure-sensitive adhesive, and a urethane-based pressure-sensitive adhesive.

11. The pressure-sensitive adhesive tape according to claim 1, wherein the pressure-sensitive adhesive layer contains a colorant.
